(19) United States
(12) Patent Application Publication
(10) Pub. No.: US 2010/0077642 A1
(43) Pub. Date: Apr. 1, 2010

(54) ADORNMENT OF FRAMED DISPLAYS

(76) Inventor: Cary Kay Kraft, Trabuco Canyon, CA (US)

Correspondence Address: MICHAEL RIES, 318 PARKER PLACE, OSWEGO, IL, 60543, US

(21) Appl. No.: 12/568,367

(22) Filed: Sep. 28, 2009

Related U.S. Application Data
(60) Provisional application No. 61/100,729, filed on Sep. 28, 2008.

(51) Int. Cl. A47G 1/06; B23P 19/04; A47G 1/17; A47G 1/24

(52) U.S. Cl. 40/711; 29/700; 40/799

(57) ABSTRACT

Adornment of a framed display comprising for example art such as a photograph or painting by coupling a sign conveying an emotion thereto, and disposed in overlying relationship to the framed art. The sign may be a charm of the type typically used with charm bracelets, wherein lettering and symbols of the charm are connected to one another and have no backfield. The charm may be coupled to the framed art by a suction cup bearing a hook, hook and loop material, double sided adhesive tape, magnet, or by a tether anchored to the rear of the framed art.

### REFERENCE TO RELATED APPLICATION

This application claims priority to U.S. Provisional Application No. 61/100,729 dated Sep. 28, 2008, the entire disclosure of which is incorporated by reference.

### TECHNICAL FIELD & BACKGROUND

The present invention generally relates to the field of framed displays such as artwork, photographs, and the like. More specifically, the present invention relates to adornment of framed displays with ornamental decorations such as jewelry charms.

Framed displays such as photographs, painted portraits, and the like are typically symbolic of strong emotional bonds between the possessor of a framed display and a human subject of a framed display. The possessor of a framed display often desires to express emotions relating to the human subject of the framed display. One way to express emotions is to inscribe an appropriate legend directly onto the photograph, painting, or other artwork which is being displayed. However, this may be difficult to do without marring or permanently altering the artwork.

Beyond the ability to formulate a satisfactory legend lies the issue of the physical form of the sentiment being expressed. It may be desirable to render the sentiment in a form more solid and long lasting than by using paper and other substances which may spontaneously curl, fade, or otherwise deteriorate with time, exposure to light, and other deleterious influences.

A further limitation of known framed displays is that while some known frames incorporate legends which could express sentiments, these legends are fixed both as to location and as to which specific sentiment is being expressed.

There exists a need in the prior art for adornment of framed displays which improve over known adornments.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates, in accordance with one embodiment of the present invention, an example of an adorned display;

FIG. 2 is a rear view of FIG. 1;

FIG. 3 is a side view of FIG. 1;

FIG. 4 is a front detail view of a component seen at the upper left of FIG. 1;

FIG. 5 is a rear view of FIG. 4;

FIG. 6 is a side view of FIG. 4;

FIG. 7 illustrates, in accordance with another embodiment of the present invention, an adorned display;

FIG. 8 is a side view of FIG. 7;

FIG. 9 is a front detail view of a component seen at the upper left of FIG. 7;

FIG. 10 is a side view of FIG. 9;

FIG. 11 illustrates, in accordance with one embodiment of the present invention, an example of apparatus for fixing the component of FIG. 9 in place;

FIG. 12 illustrates, in accordance with a further embodiment of the present invention, an example of another apparatus for fixing the component of FIG. 9 in place;

FIG. 13 illustrates, in accordance with still another embodiment of the present invention, another apparatus for fixing the component of FIG. 9 in place;

FIG. 14 illustrates, in accordance with still a further embodiment of the present invention, a further example of apparatus for fixing the component of FIG. 9 in place; and

FIG. 15 is a block diagram summarizing steps of a method of practicing the invention according to still another embodiment thereof.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

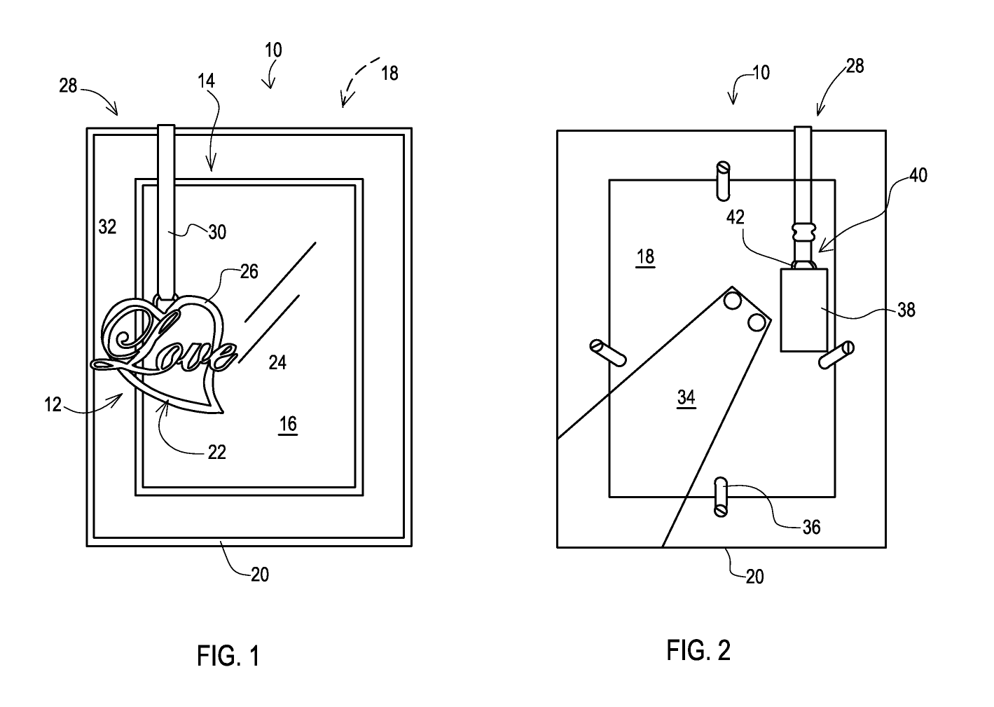

Referring now to FIG. 1, illustrated is a first embodiment of a display comprising framed art 10 bearing an adornment 12 which is fixed thereto. The framed art 10 may comprise a substrate 14 having a face 16 bearing artwork (not shown in full detail) and a rear 18 which is not intended to be viewed. The face 16 is that side of the artwork and a surrounding picture frame 20 which are exposed to full view for display purposes. The rear 18 is opposed to the face 16.

The picture frame 20 is disposed to frame and support the substrate 14. Framing the substrate 14 signifies that the picture frame 20 presents a border extending about the full periphery of the substrate 14, such as at all four sides of a rectangle such as that depicted in FIG. 1. The adornment 12 may comprise a charm 22 which is disposed in overlying relationship to the face 16. For the purposes of this invention, a charm is an object of the type typically used with charm bracelets, wherein lettering, symbols, and fictitious and simulated humanoid or animate figures form a continuous object, and are devoid of a backfield. Illustratively, the charm 22 comprises indicia 24 which spells out the word “love” which overlies a heart shaped frame 26 which is fused or bonded to or integral with to the letters of the word “love”. The heart shaped frame 26 and the indicia 24 have no backfield. The word “love” conveys an emotion. Charms such as the charm 22 convey emotional subject matter, which may be spelled out as a word, or may comprise a symbol such as the heart of the heart shaped frame 26, or may comprise another symbol or object which is widely associated with an emotion.

The charm 22 may be disposed in overlying relationship to the face 16. More specifically, the charm 22 may overlie just the artwork, just a forwardly exposed portion of the picture frame 20, or may span both.

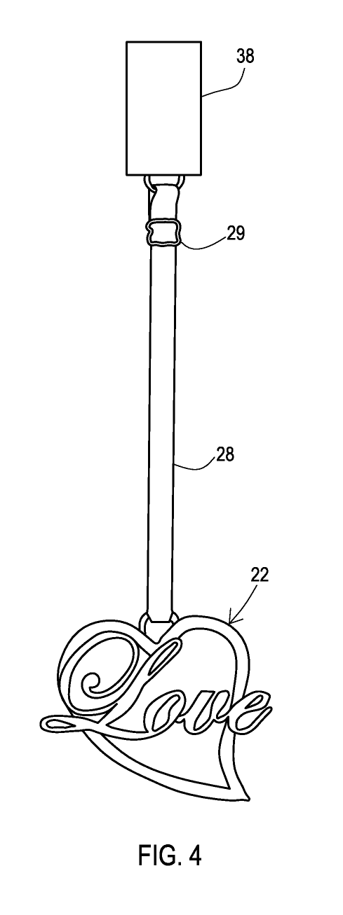

A flaccid tether 28 may couple the charm 22 to the framed art 10. The flaccid tether 28 may comprise a flexible strip 30 of material, such as a ribbon, leather, metallic chain, or other flexible elongated member. The flaccid tether 28 may have a proximal end 32 coupled to the sign or charm 22, and a distal end and an anchor (see FIG. 2) disposed to couple the flaccid tether 28 to the framed art 10. An adjuster 29 (called out by reference numeral in FIG. 4) may be utilized to selectively adjust the effective length of the flaccid tether 28.

The flexible strip 30 of material provides a bendable connection between the sign or charm 22 and an anchorage device fastening the flaccid tether 28 to the picture frame 20 or the artwork held thereby.

Referring specifically to FIG. 2, the rear 18 of the framed art 10 is seen. The picture frame 20 may comprise conventional elements of picture frames generally, such as a fold out propping leg 34 and a plurality of tabs 36 (one of four similar tabs is called out by reference numeral 36). The flaccid tether 28 may terminate in an adherable anchorage substrate 38 which is disposed to couple the sign or charm 22 in overlying relation to the face 16 (as seen in FIG. 1). This may be accomplished by fastening the charm 22 at the rear 18, as seen in FIG. 2, or alternatively by fastening the charm 22 at the face 16, as described hereinafter.

The flaccid tether 28 may terminate at a loop 40 for encircling a ring 42 fixed to the adherable anchorage substrate 38.

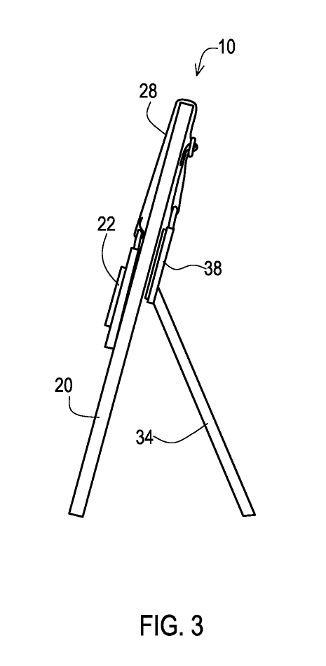

FIG. 3 shows a side view of FIG. 1. It will be seen from FIG. 3 that when the adherable anchorage substrate 38 adheres to the rear 18, the flaccid tether 28 may lie generally flat against the face 16 and the rear 18 of the framed art 10.

Fastening at the rear 18 may utilize the adherable anchorage substrate 38, which may bear adhesive or hook and loop fastener as desired. If hook and loop fastener is utilized, a patch of complementing hook and loop material may be adhered to the rear 18 to engage the hook and loop affixed to the adherable anchorage substrate 38.

Two significant advantages of the present invention are that the sentiment being expressed by the sign or charm 22 may be changed as to content and also as to location on the face 16. An owner of artwork adorned according to one or more aspects of the invention may wish to change the sentiment from time to time. In one example, a grandparent of a grandchild may wish to change the legend “love” to “happy birthday” on the birthday of the grandchild, and then revert to “love” at other times. To do this, the charm 22 may be removed and temporarily replaced with another charm or sign (not shown).

Location of the sign or charm 22 may be changed. In another example, a grandparent may have a framed photograph adorned according to one or more aspects of the invention, wherein the photograph is that of several family members. The grandparent may wish to move a sign or charm bearing the legend “happy birthday” from a location proximate one family member to a second location proximate a second family member as each birthday arrives. In a further example, the legend may be changed to reflect arrival of holidays or other significant days or events in the lives of the subjects of the adorned display. Illustratively, rites of passage such as graduation, religious confirmation, bar or bat mitzvahs, weddings, receipt of honors or recognition, weddings, and still other events and achievements may be the subject of expressed sentiments.

Of course, adjustment of position of the sign or charm 22 may be accomplished by varying the location of attachment of the adherable anchorage substrate 38 in a vertical direction, in a horizontal direction, or both. It may be that there are locations where it is not suitable to attach the adherable anchorage substrate 38. This may occur for example where mounting would interfere with the propping leg 34 or a tab 36. Adjustment of length of the flexible tether 28 may be utilized to adjust vertical location of the adherable anchorage substrate 38. Adjustment of length using the adjuster 29 may be supplemental to repositioning of the adherable anchorage substrate 38.

It will be seen that rear anchorage provided by the adherable anchorage substrate 38 provides near universal positioning of the anchorage and hence of the sign or charm 22 over both the framed art 10 and any glass which may overlie the framed art 10. Even the top or the sides may serve as the final location of the sign or charm 22. It will also be appreciated that rear anchorage also minimizes intrusion of the anchorage with regards to visibility of the framed art 10.

Further advantages of the invention, and more particularly to the specifics of mounting a sign or charm 22 are that the novel mounting apparatus accommodates frames of different dimensions and of different configurations. No predetermined cooperation with any particular frame or configuration thereof is necessary. Therefore, the sign or charm 22 may quickly be mounted to any one of many pre-existing frame designs.

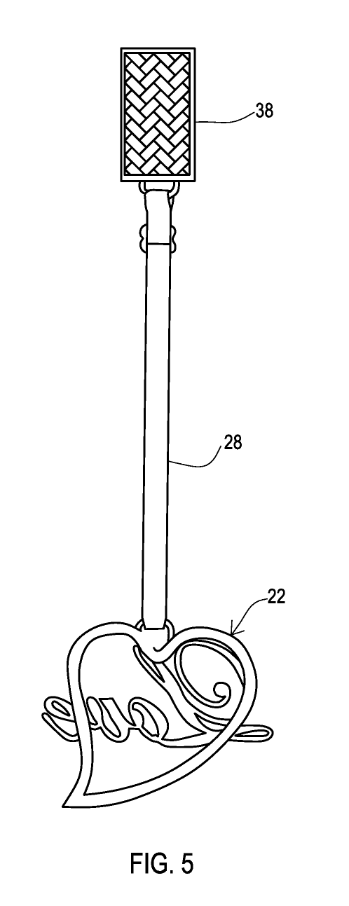

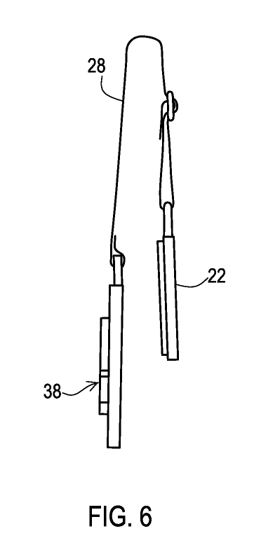

FIGS. 4, 5, and 6 present front and rear views respectively of the charm 22, the flexible tether 28, and the adherable anchorage substrate 38, in all cases shown isolated from the framed art 10.

While adhesive and hook and loop fastening material are not shown in FIGS. 2 and 3, these fasteners may be utilized as generally described and illustrated as will be described hereinafter.

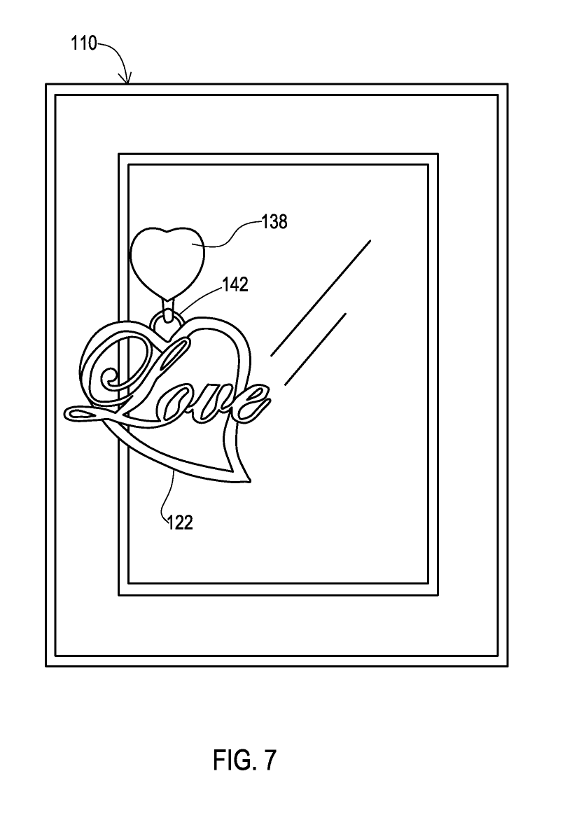

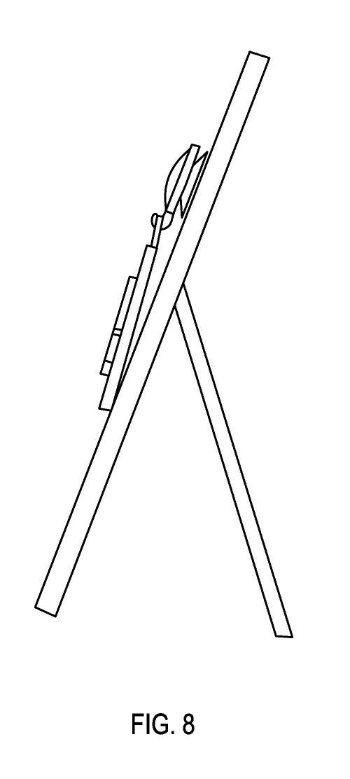

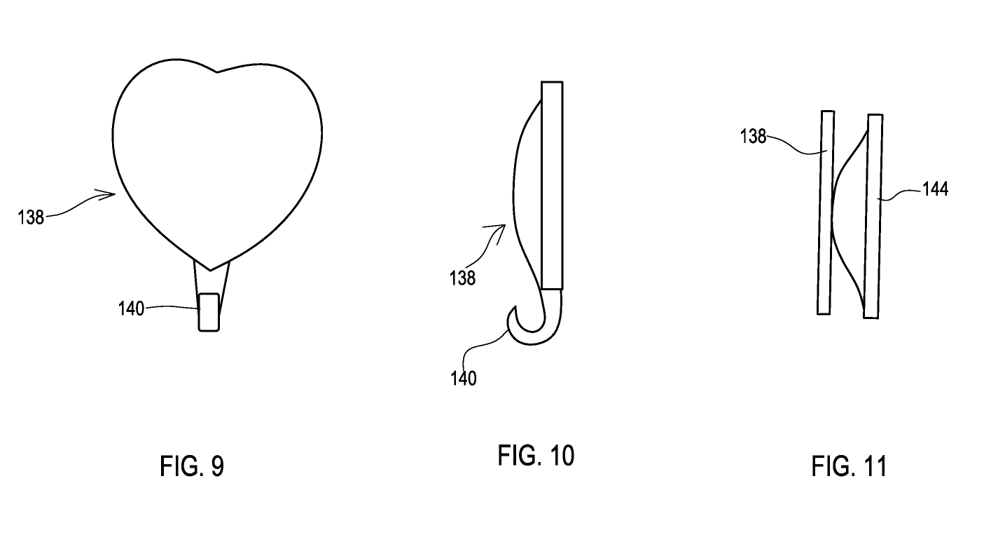

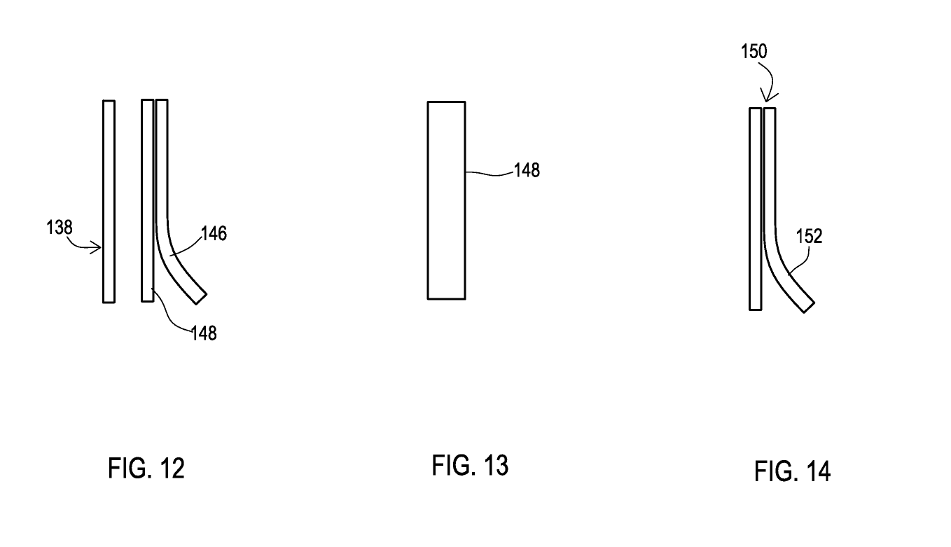

FIG. 7 shows a charm 122 coupled to framed art 110, but on a face 116 of the framed art 110. The framed art 110 and the charm 122 may be similar structurally and functionally to their similarly named counterparts of FIGS. 1-6, and therefore need no further description. The charm 122 may be suspended from an adherable anchorage substrate 138, which is shown in front view and side view respectively in FIGS. 9 and 10. The adherable anchorage substrate 138 may comprise a hook 140 for engaging a ring 142 formed as part of the charm 122. Of course, because of the open construction of the charm 122 due to lack of solid backfield, the hook 140 may engage an open portion of the charm 122 if desired. Engagement of the ring 142 provides a bendable connection in linkage of the adherable anchorage substrate 138 to the face 116 of the framed art 110.

The adherable anchorage substrate 138 may be adhered in any suitable way. For example, and referring now to FIG. 11, the adherable anchorage substrate 138 may utilize a suction cup 144 fixed thereto.

In an alternative to the suction cup 144, the adherable anchorage substrate 138 may utilize a first patch 146 of hook and loop fastening material having adhesive on one side, such that the first patch 146 of hook and loop fastening material remains on the framed art 110, and a second patch 148 of hook and loop fastening material which may be adhered or otherwise suitably fixed to the adherable anchorage substrate 138.

In a further alternative to the suction cup 144, the adherable anchorage substrate 138 may comprise a magnet 148 fixed thereto (see FIG. 13). The magnet 148 may be adhered to the adherable anchorage substrate 138 and may be used in cases when the frame of the framed art 110 comprises steel or another magnetically responsive material. The magnet 148 may be dimensioned and configured to be engaged by adhesive of double sided adhesive tape, where double sided adhesive tape is used to fasten the magnet 148 to the adherable anchorage substrate 138.

The magnet 148 may be adhered in place using double sided adhesive tape 150, as seen in FIG. 14. The double sided adhesive tape 150 may include a release liner 152 which exposes one of the two sides bearing adhesive (not separately shown). The other side of the adhesive tape 150 may have a similar release liner (not shown).

A patch of hook and loop fastening material, such as the patch 146, may be of the type which is commercially available with adhesive disposed on one side and with a release liner for covering the adhesive prior to use (this form of hook and loop fastener is not specifically shown).

In a further option, the adherable anchorage substrate 138 may be connected using a piercing fastener such as a thumbtack, a push pin, or the like. The adherable anchorage substrate used with piercing fasteners may still include adhesive or hook and loop fastening material, or may be devoid of these materials.

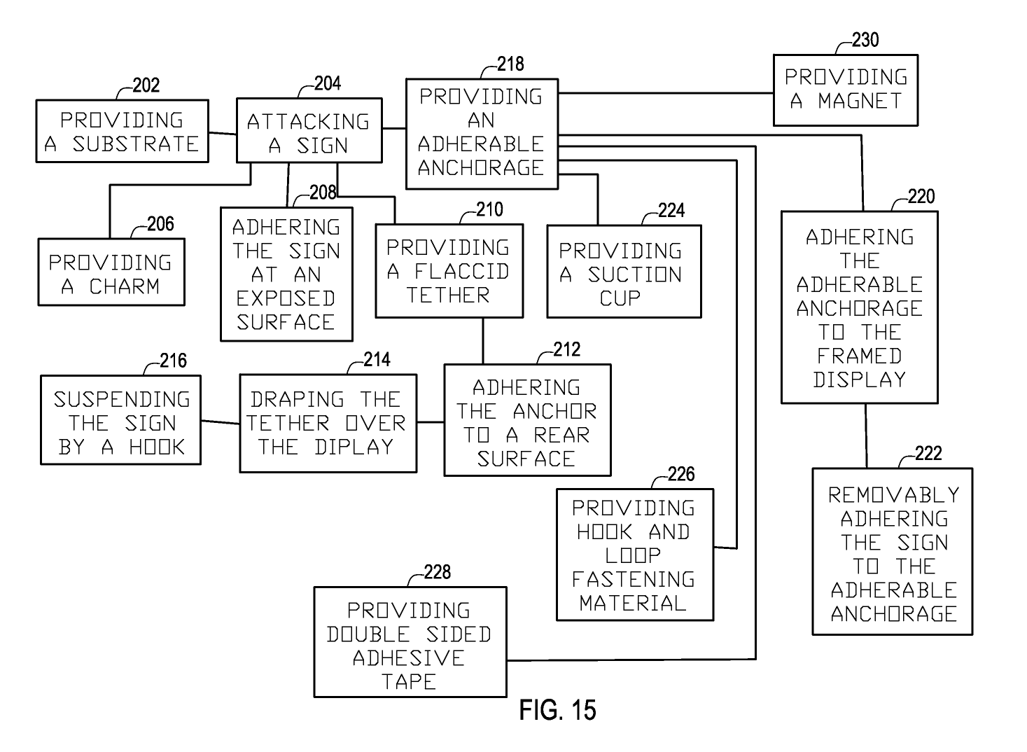

The invention may be thought of as a method 200 of adorning a framed display, such as the framed art 10 of FIG. 1. Steps of the method 200, which are summarized in FIG. 15, may utilize the constructions of framed art described above, for example. The method 200 may comprise a step 202 of providing a substrate having a face bearing artwork and a rear, and a picture frame disposed to frame and support the substrate; and a step 204 of attaching to the picture frame a sign conveying an emotion such that the sign is removable from and disposed in overlying relationship to the face.

The step 204 may comprise a further step 206 of providing a charm in a form spelling a word related to an emotion.

The step 204 may comprise a further step 208 of adhering the sign at an exposed surface of the artwork.

The step 204 may comprise a further step 210 of providing a flaccid tether having a proximal end coupled to the sign and a distal end terminating at an anchor for fixing the tether to the framed display; a further step 212 of adhering the anchor to a rear surface of the artwork; and a still further step 214 of draping the flaccid tether over the framed display such that the sign overlies the face.

The method 200 may comprise a further step 216 of suspending the sign from the flaccid tether by a hook.

The step 204 may comprise a further step 218 of providing an adherable anchorage substrate; a further step 220 of adhering the adherable anchorage substrate to the framed display; and a further step 222 of removably adhering the sign to the adherable anchorage substrate.

The step 218 may comprise the further step 224 of providing a suction cup having a hook fixed thereto.

The step 218 may comprise a further step 226 of providing a patch of hook and loop fastening material having adhesive on one side and one member of hook and loop fastening material on an opposed side.

The step 218 may comprise the further step 228 of providing double sided adhesive tape.

The step 218 may comprise the further step 230 of providing a magnet.

Thus, it can be seen from the above descriptions, adorned framed displays and methods of adorning framed displays have been described. While the present invention has been related in terms of the foregoing embodiments, those skilled in the art will recognize that the invention is not limited to the embodiments described. The present invention can be practiced with modification and alteration within the spirit and scope of the appended claims.

Thus, the description is to be regarded as illustrative instead of restrictive on the present invention.

1. A method of adorning a framed display, comprising the steps of:
providing a substrate having a face bearing artwork and a rear, and a picture frame disposed to frame and support the substrate; and
attaching to the picture frame a sign conveying an emotion such that the sign is removable from and disposed in overlying relationship to the face, using an anchorage which is connected to the sign by a link incorporating a bendable connection therein.

2. The method of claim 1, wherein said step of attaching to the picture frame a sign conveying an emotion such that the sign is removable from and disposed in overlying relationship to the face comprises the further step of providing a charm in a form spelling a word related to an emotion.

3. The method of claim 1, wherein said step of attaching to the picture frame a sign conveying an emotion such that the sign is removable from and disposed in overlying relationship to the face comprises the further step of adhering the sign at an exposed surface of the artwork.

4. The method of claim 1, wherein said step of attaching to the picture frame a sign conveying an emotion such that the sign is removable from and disposed in overlying relationship to the face comprises the further steps of:
providing a flaccid tether having a proximal end coupled to the sign and a distal end terminating at an anchor for fixing the tether to the framed display;
adhering the anchor to a rear surface of the artwork; and
draping the flaccid tether over the framed display such that the sign overlies the face.

5. The method of claim 4, comprising the further step of suspending the sign from the flaccid tether by a hook.

6. The method of claim 1, wherein said step of attaching to the picture frame a sign conveying an emotion such that the sign is removable from and disposed in overlying relationship to the face comprises the further steps of:
providing an adherable anchorage substrate;
adhering the adherable anchorage substrate to the framed display; and
removably adhering the sign to the adherable anchorage substrate.

7. The method of claim 6, wherein said step of providing an adherable anchorage substrate comprises the further step of providing a suction cup having a hook fixed thereto.

8. The method of claim 6, wherein said step of providing an adherable anchorage substrate comprises the further step of providing a patch of hook and loop fastening material having adhesive on one side and one member of hook and loop fastening material on an opposed side.

9. The method of claim 6, wherein said step of providing an adherable anchorage substrate comprises the further step of providing double sided adhesive tape.

10. The method of claim 9, wherein said step of providing an adherable anchorage substrate comprises the further step of providing a magnet.

11. A framed display bearing an adornment fixed thereto, comprising:
a substrate having a face bearing artwork and a rear;
a picture frame disposed to frame and support said substrate;
a sign having indicia conveying an emotion and disposed in overlying relationship to said face of said substrate; and
a connector disposed to hold said sign in said overlying relationship to said face, wherein said connector comprises a bendable connection therein.

12. The framed display of claim 11, wherein said sign is a charm, and said indicia comprises letters spelling a word related to an emotion.

13. The framed display of claim 11, further comprising a flaccid tether having a proximal end coupled to said sign, a distal end, and an anchor disposed to couple said tether to said framed display.

14. The framed display of claim 11, further comprising an adherable anchorage substrate disposed to couple said sign in overlying relation to said face.

15. The framed display of claim 14, wherein said adherable anchorage substrate comprises a suction cup.

16. The framed display of claim 14, wherein said adherable anchorage substrate comprises a patch of hook and loop fastening material having adhesive on one side of said adherable anchorage substrate and one member of hook and loop fastening material on an opposed side of said adherable anchorage substrate.

17. The framed display of claim 14, wherein said adherable anchorage substrate comprises double sided adhesive tape.

18. The framed display of claim 17, further comprising a magnet which is dimensioned and configured to be engaged by adhesive of said double sided adhesive tape.

19. The framed display of claim 13, further comprising an adjuster disposed to selectively adjust the length of said tether.
